(19) United States
(12) Patent Application Publication
(10) Pub. No.: US 2014/0094341 A1
(43) Pub. Date: Apr. 3, 2014

(54) HYBRID MODULE FOR A DRIVETRAIN OF A VEHICLE

(71) Applicant: Schaeffler Technologies AG & Co. KG, Herzogenaurach (DE)

(72) Inventors: Willi Ruder, Lahr (DE); Dierk Reitz, Baden-Baden (DE)

(73) Assignee: Schaeffler Technologies AG & Co. KG, Herzogenaurach (DE)

(21) Appl. No.: 14/099,257

(22) Filed: Dec. 6, 2013

Related U.S. Application Data
(63) Continuation of application No. PCT/DE2012/000484, filed on May 11, 2012.

(30) Foreign Application Priority Data
Jun. 9, 2011 (DE) DE102011103772.5

(51) Int. Cl. B60K 6/383

(52) U.S. Cl. CPC B60K 6/383
USPC 477/5

(57) ABSTRACT

A hybrid module for a drivetrain of a motor vehicle having a combustion engine and a transmission, wherein the hybrid module operates between the combustion engine and the transmission and has an electric drive, a decoupling clutch and a freewheeling mechanism, and wherein the decoupling clutch and the freewheeling mechanism, parallel to each other, are each provided to transmit torque from the combustion engine in the direction of the transmission, the freewheeling mechanism transmits torque coming from the combustion engine in the direction of the transmission and disengages in the case of torque in the opposite direction.

This is a continuation and claims the benefit of International Application PCT/DE2012/000484, filed May 11, 2012 which claims the benefit of German Patent Application DE 10 2011 103 772.5, filed Jun. 9, 2011, both applications are hereby incorporated by reference herein.

The present invention relates to a hybrid module for a drivetrain of a vehicle having an internal combustion engine and a transmission.

### BACKGROUND

A hybrid drivetrain of a motor vehicle is known from DE 10 2009 032 336 which comprises a combustion engine, a dual mass flywheel (“DMF”), an electric drive and a transmission, wherein a decoupling clutch is situated between the combustion engine and the electric drive. This decoupling clutch situated on the engine side serves to decouple the combustion engine from the rest of the drivetrain, for example in order to drive the vehicle purely electrically, and is integrated into the rotor of the electric drive. Situated between the output-side DMF and the friction clutch is an intermediate shaft, whereby the torque coming from the combustion engine is transmitted to a hub of a clutch plate of the decoupling clutch, there being an axial spline connection provided between the hub and the intermediate shaft. Radial forces through the DMF on the intermediate shaft can result in high forces on the bearings and in misalignments of the intermediate shaft on the engine side, or in skewing of the intermediate shaft.

### SUMMARY OF THE INVENTION

It is an object of the present invention to improve the support of the hybrid module for a drivetrain of a vehicle having an internal combustion engine and a transmission.

The present invention provides a hybrid module for a drivetrain of a vehicle having a combustion engine, torsional vibration damper, hybrid module and transmission, wherein the hybrid module operating between the combustion engine and the transmission has an electric drive, a decoupling clutch and a freewheeling mechanism, and wherein the decoupling clutch and the freewheeling mechanism, parallel to each other, are each provided to transmit torque from the combustion engine in the direction of the transmission, the freewheeling mechanism transmits torque coming from the combustion engine in the direction of the transmission and disengages in the case of torque in the opposite direction, and wherein the torsional vibration damper and the hybrid module are connected with each other through an intermediate shaft which is supported on the engine side through a pilot bearing system situated directly on a crankshaft of the combustion engine, or indirectly on the crankshaft through the torsional vibration damper.

A hybrid module for a drivetrain/drive line of a motor vehicle having a combustion engine, torsional vibration damper, hybrid module and transmission, wherein the hybrid module operating between the combustion engine and the transmission has an electric drive, a decoupling clutch and a freewheeling mechanism, and wherein the decoupling clutch and the freewheeling mechanism, parallel to each other, are each provided to transmit torque from the combustion engine in the direction of the transmission, the freewheeling mechanism transmits torque coming from the combustion engine in the direction of the transmission and disengages in the case of torque in the opposite direction, is also referred to hereinafter as a “free-wheel decoupling clutch module.”

According to an especially preferred exemplary embodiment, depending on the operating state of the freewheeling mechanism the intermediate shaft is supported on the transmission side either through the freewheeling bodies themselves when the freewheeling mechanism is engaged, or through a bearing (in particular a deep groove ball bearing or a journal bearing) when the freewheeling mechanism is disengaged. In this preferred exemplary embodiment the intermediate shaft of the free-wheel decoupling clutch module is supported on the one hand on the engine side in the pilot bearing (roller bearing or journal bearing) and on the other hand by an additional bearing (roller bearing or journal bearing) in proximity to the freewheeling mechanism or the freewheeling bodies themselves. As a result, skewing of the intermediate shaft on the engine side is prevented or reduced by radial forces on the secondary side of the damper

Preferably, a portion of the torque generated by the combustion engine which is transmitted by the freewheeling mechanism is set by adjusting a torque transmissible by the decoupling clutch, so that the vehicle can optionally be propelled by the combustion engine or the electric drive or simultaneously by both of them combined. In this exemplary embodiment, the function of the decoupling clutch on the engine side which is known from the existing art is divided between two components which are situated parallel to each other in the flow of torque, namely a decoupling clutch and a freewheeling mechanism. When the decoupling clutch is disengaged, the entire torque produced by the combustion engine is transmitted through the freewheeling mechanism to the transmission. Accordingly, the freewheeling mechanism should be designed so that its transmissible torque corresponds to the torque producible by the combustion engine. In contrast, the torque transmission capacity of the decoupling clutch in this exemplary embodiment can be chosen to be significantly lower than the torque producible by the combustion engine. For example, for a torque of 700 to 800 Nm producible by the combustion engine, the decoupling clutch can be designed for 100 Nm to 130 Nm, whereas the freewheeling mechanism should also be designed for 700 Nm to 800 Nm. If the decoupling clutch is partially engaged, then the torque transmissible by the freewheeling mechanism is reduced, corresponding to the torque transmissible by the decoupling clutch. In other words, the total torque produced by the combustion engine is divided between the freewheeling mechanism and the decoupling clutch, corresponding to the torque transmissible by the decoupling clutch (which depends in turn on an actuating force of the decoupling clutch). At the same time, the decoupling clutch can remain engaged or be kept engaged when the present drivetrain is operating in combustion engine mode, so that, as a rule, torque is divided between the clutch and the freewheeling mechanism. However, under certain circumstances it can be advantageous here to disengage the clutch at least partially or keep it partially disengaged when operating in combustion engine mode, for example when upshifting under traction or when upshifting under drag.

With the present decoupling clutch, torque can be transmitted in the direction of the combustion engine (the freewheeling mechanism disengages in this direction of transmission of the torque). Correspondingly, with the decoupling clutch engaged, tow-starting of the combustion engine from the electric driving (for example at 80 to 130 Nm) can be realized, as well as transmission of drag torque in the case of a fully charged battery (for example up to 90 Nm).

As described above, the present hybrid module comprises a decoupling clutch and a freewheeling mechanism connected in parallel, where the torque from the combustion engine can be transmitted in the direction of the drivetrain exclusively by the freewheeling mechanism, or by the freewheeling mechanism and the decoupling clutch jointly, or possibly exclusively through the decoupling clutch. Additionally, torque directed from the drivetrain in the direction of the combustion engine is transmitted exclusively through the decoupling clutch.

Advantageously, the decoupling clutch is designed as a “normally open” clutch, meaning that it is designed to be disengaged in its normal state and is pulled or pressed into the engaged state by means of a closing force. This is advantageous inasmuch as the clutch in the present drivetrain is disengaged up to 70% of the time under normal operation of a vehicle equipped with such a hybrid module. The efficiency of the actuator is accordingly more favorable under such boundary conditions with a normally open clutch than with a normally closed clutch. Advantageously, according to an alternative embodiment the decoupling clutch is designed as a normally closed clutch, meaning that it is designed to be engaged in its normal state and is disengaged by means of an opening force, preferably pulled or pressed into the disengaged state. Such a decoupling clutch is utilized for the drive line of a vehicle in particular when in normal operation of the vehicle equipped with this hybrid module the decoupling clutch is normally engaged, preferably is engaged more than 50% of the time during operation, by preference more than 60%. The efficiency of the actuator is accordingly more favorable under such boundary conditions with a normally closed clutch than with a normally open clutch.

The freewheeling mechanism is preferably designed as a roller-type freewheel, by preference as a sprag-type freewheel. The freewheeling mechanism preferably has a freewheel input part, a freewheel output part and at least one, by preference a plurality of blocking elements situated between this freewheel input part and this freewheel output part. Preferably, a freewheeling mechanism has a freewheel input part designed as an inner ring and a freewheel output part designed as an outer ring, or vice versa. Preferably, torque is transmitted from the crankshaft of the combustion engine directly to the freewheel input part.

The freewheeling mechanism is preferably situated axially, in the direction from the combustion engine to the transmission device, behind the torsional vibration damper, by preference behind the dual mass flywheel. Also preferably, this freewheeling mechanism is situated in the same axial direction before a central bearing. Preferably, the central bearing is provided to support at least part of the decoupling clutch and/or at least part of an electromechanical energy converter, preferably an electromechanical energy converter which serves to propel the vehicle, and by particular preference a rotor of that electromechanical energy converter.

Also preferably, this freewheeling mechanism is situated axially between that dual mass flywheel and that central bearing. In particular due to the arrangement of the freewheeling mechanism between the dual mass flywheel and the central bearing, a hybrid module needing little construction space is made possible.

Preferably, the actuating mechanism is situated in a region of the hybrid module that is adjacent to this combustion engine, preferably to the crankshaft of the combustion engine. Alternatively, the actuating mechanism may be situated in a region of the hybrid module that is adjacent to this transmission, preferably to a transmission input shaft of this transmission. Also alternatively, the actuating mechanism may be situated in a region of the hybrid module which lies essentially symmetrically between this combustion engine and this transmission.

Preferably, the decoupling clutch is actuated by means of a hydraulic actuating mechanism. Also preferably, this hydraulic actuating mechanism has a hydraulic cylinder, preferably having an annular area. Preferably, the decoupling clutch is actuated by means of an electromechanical actuating mechanism. Also preferably, such an electromechanical actuating mechanism has at least one electromechanical energy converter, preferably an electric motor. The actuating mechanisms can be utilized independently of the type of decoupling clutch (“normally open/closed”).

### BRIEF DESCRIPTION OF THE DRAWINGS

The present invention will be explained in greater detail below on the basis of preferred exemplary embodiments in connection with the associated figures. They show the following:

FIG. 1 a schematic depiction of a drive line of a vehicle having the present hybrid module,

FIG. 2 an embodiment of the present hybrid module, having two (radial) bearings next to the freewheeling mechanism, wherein a radial force from the damper is introduced at the engine end of the intermediate shaft,

FIGS. 3A and 3B another exemplary embodiment of the present hybrid module, having a system of centering/supporting of the intermediate shaft by means of a journal or needle bearing as a pilot bearing in the crankshaft, and exactly one bearing point on the transmission side,

FIGS. 4A and 4B an exemplary embodiment of the hybrid module having a system of supporting the intermediate shaft in the primary side of the damper, and

FIGS. 5A and 5B another exemplary embodiment of the hybrid module having a system of supporting the intermediate shaft in the secondary side of the damper, and a system of supporting the secondary side of the damper in the primary side of the damper.

### DETAILED DESCRIPTION

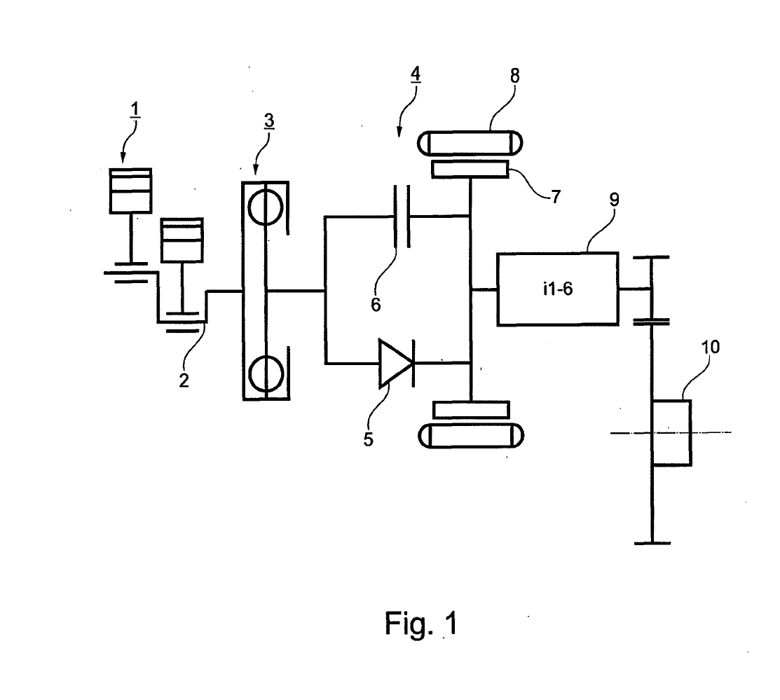

FIG. 1 shows a schematic view of a drive line of a vehicle having a combustion engine 1, a torsional vibration damper 3 (in the present case a dual mass flywheel) connected to a crankshaft 2 of the combustion engine 1, a hybrid module 4 having a freewheeling mechanism 5 and a decoupling clutch 6, and having a rotor 7 and stator 8 of an electric drive, a transmission 9, a differential 10 and driven wheels.

FIG. 1 is to be understood as only an example. Thus the combustion engine 1 according to the depiction in FIG. 1 has “only” two cylinders. However, the present teaching is not limited to such a concrete number of cylinders. On the contrary, more than two cylinders for the combustion engine 1 would also be conceivable, or even a parallel and series connection of a plurality of combustion engines. In addition, FIG. 1 shows a dual mass flywheel. Alternatively to this, a single mass flywheel or some other type of vibration damping could also be used, such as a mass pendulum or centrifugal force pendulum or a combination of such damping elements. Depending on the quietness of operation of the combustion engine or engines, such a damping unit could possibly also be dispensed with. Also shown in FIG. 1 as a transmission is a(n automated) six-stage shift transmission 9, without the present teaching being limited thereto. On the contrary, the design of the transmission as an automatic transmission/multi-step transmission/CVT (continuously variable transmission) or other types of transmission such as crank transmission, possibly in combination with an additional separating unit between transmission and electric drive 7, 8 (such as a torque converter, an additional decoupling clutch like a dry or wet dual clutch or similar sub-assemblies) is also conceivable.

The particular point that may be taken from FIG. 1 about the present hybrid module is that two parallel torque transmission lines are provided between the combustion engine 1 and the transmission 9, a first one having the decoupling clutch 6 and a second one having the freewheeling mechanism 5, so that the functions of the engine-side decoupling clutch known from the existing art are divided between two components which differ from each other. So the torque produced by the combustion engine 1 can be divided between the decoupling clutch and the freewheeling mechanism, independently of any actuating force present at the clutch.

The freewheeling mechanism transmits when torque is transmitted from the combustion engine 1 to the transmission 9 (as may be seen from FIG. 1), and disengages when the direction of torque flow is from the transmission to the combustion engine 1. Torques from the transmission 9 in the direction of the combustion engine 1 can be transmitted when the clutch is engaged. This pertains in particular to tow-starting the combustion engine from the electric driving, as well as to the transmission of drag torque in the event of a fully charged battery.

However, in the combustion engine mode of the drive line the decoupling clutch normally remains engaged, so that the latter in any case transmits a share of the transmissible torque from the combustion engine corresponding to its available torque transmitting capacity.

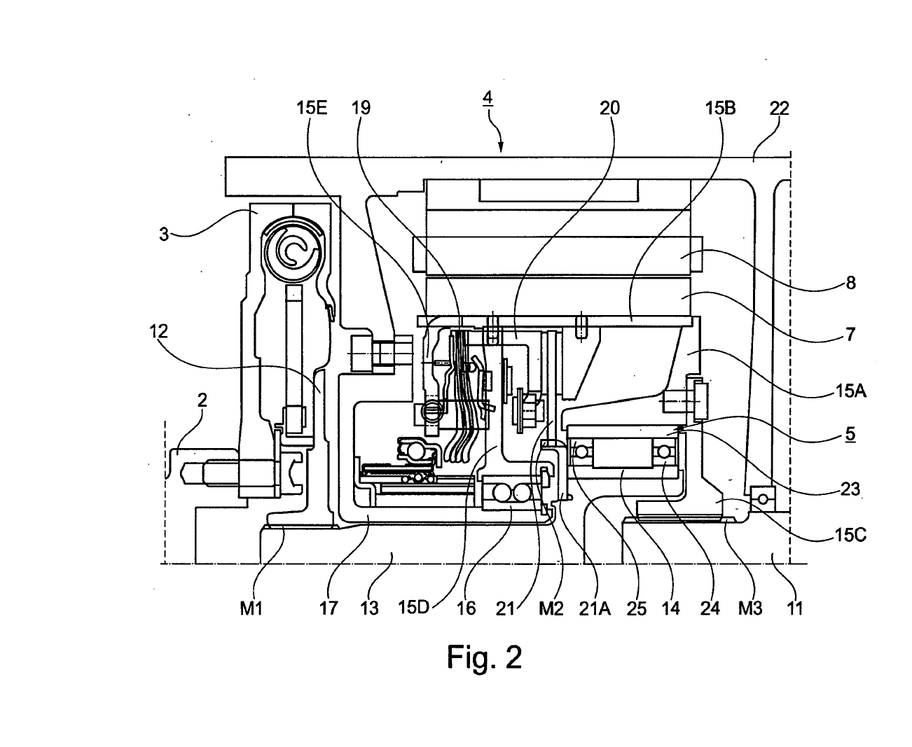

One design of the diagram shown in FIG. 1 can be taken from FIG. 2, which shows the hybrid module 4 between the dual mass flywheel (“DMF”) 3 and a transmission input shaft 11 of the transmission 9 in a half-sectional view, wherein an output side 12 of the DMF 3 (=secondary side of the DMF=output flange of the DMF) is connected to the input shaft 13, in the present case by means of an axial spline connection Ml. Accordingly, the entire torque produced by the combustion engine 1 is transmitted to the intermediate shaft 13 of the hybrid module through the mediation of the DMF 3. The central component here is the intermediate shaft 13, which is connected on the one hand to an inner ring 14 of the freewheeling mechanism 5 or has a tube-like appendage that is configured directly as an inner ring 14 of the freewheeling mechanism, and which is connected on the other hand to a clutch plate 21 of the decoupling clutch by means of an additional axial spline connection M2.

An outer ring 23 of the freewheeling mechanism 5 is connected to a part 15A of the decoupling clutch 4, which together with the component 15B forms the clutch housing 15, the component 15B simultaneously being part of the rotor of the electric drive.

The clutch housing 15 is connected to the transmission input shaft 11 of the transmission 9, preferably through an additional spline connection M3, while there may be an additional decoupling clutch (for example a converter or another friction clutch, such as a dry or wet dual clutch) situated between the clutch housing 15 and the transmission input shaft 11.

The component 15B of the clutch housing 15 is essentially cylindrical in form, and together with the supporting element 15D forms the rotor 7 of the electric drive. Thus, in the present case, the permanent magnets of the rotor are attached directly to the cylindrical part 15B of the clutch housing. At the same time, the supporting element 15D has in its radially inner region a tube-like section, which is supported on a central bearing 16.

The central bearing 16 in turn is situated on a housing 17 of the actuating mechanism 18 of the decoupling clutch 6 or on a tube-like component 17 on which the actuating mechanism can be supported. The actuating unit 18 is attached to the transmission housing 22.

In the present case, the actuating mechanism 18 comprises a hydraulic actuating unit having a hydraulic cylinder situated concentrically to the intermediate shaft 13, which cylinder actuates a lever spring 19 which is supported on a radially extending region 15E of the clutch housing 15 of the decoupling clutch 6 and which can apply an actuating force in an axial direction to a pressure plate 20 corresponding to the position of the actuating cylinder. Corresponding to an axial movement of the pressure plate 20, the clutch plate 21 is clamped between the pressure plate 20 and the clutch housing of the decoupling clutch 6, whereby the decoupling clutch 6 can be engaged. The clutch plate 21 of the decoupling clutch 6 is non-rotatingly connected to the intermediate shaft 13 by means of the axial spline connection M2 and by means of a hub component 21A.

As shown in FIG. 2, the central bearing 16 (which is designed in the present case as a fixed bearing) can be situated essentially axially next to (that is, at a comparable diameter to) the freewheeling mechanism 5, while the inner ring of the freewheeling mechanism or the intermediate shaft takes over the link to the clutch plate and to the dual mass flywheel, and while an outer cage of the freewheeling mechanism 5 is connected to the transmission input through the clutch housing 15.

The exemplary embodiment according to FIG. 2 shows an engine-side decoupling clutch of a hybrid module, in particular the support system for the intermediate shaft. The intermediate shaft and the freewheeling mechanism are supported by means of two bearings 24, 25, which are situated directly next to the freewheeling body.

As described at the beginning, the intermediate shaft 13 in the exemplary embodiment according to FIG. 2 is supported in two different manners, depending on the function or operating state of the freewheeling mechanism:

1) freewheeling mechanism engaged (i.e., freewheeling mechanism transmits torque):
The shaft is centered for the most part by means of the freewheeling mechanism itself, by locking the freewheeling bodies against the freewheel housings. The two radial bearings beside the freewheeling body are nearly load-free in this state. Radial forces on the damper result in a tipping moment on the freewheeling bodies, and subject them to an additional load. The magnitude of the tipping moment is dependent on the radial forces on the take-off side of the damper, or on the transmitted torque.

2) freewheeling mechanism disengaged (i.e., in neutral):
The shaft 13 is centered by means of the two radial bearings 24, 25 which are situated next to the freewheeling mechanism 5. The freewheeling mechanism itself has no self-centering function in this function. Radial forces from the damper 3 result in loads on the two bearings 24, 25. The magnitude of the tipping moment is dependent on the radial forces on the take-off side of the damper, or on the transmitted torque.
Above all in the engaged state, but also in the disengaged state of the freewheeling mechanism, the radial forces of the secondary side of the damper can be so high that this results in a radial misalignment of the intermediate shaft through the spline connection on the engine side, and hence also in additional loading on the freewheeling mechanism.

However, radial forces due to the damper through the spline connection on the intermediate shaft can result in high forces on the bearings or the freewheeling body, and because of the unfavorable lever arms can result in misalignments of the intermediate shaft on the engine side, or to skewing of the intermediate shaft. Radial forces of the secondary side of the damper on the intermediate shaft arise due to radial misalignments of the axis of rotation of the damper (primary) to the axis of rotation of the intermediate shaft due to static tolerances or to radial movements of the crankshaft. The strength of the radial forces is dependent on the transmitted torque of the damper, and hence on the operative engine torque of the combustion engine.

An exemplary embodiment having a modified bearing variant will now be described, whereby the bearing forces are reduced and the radial misalignments of the intermediate shaft are lessened.

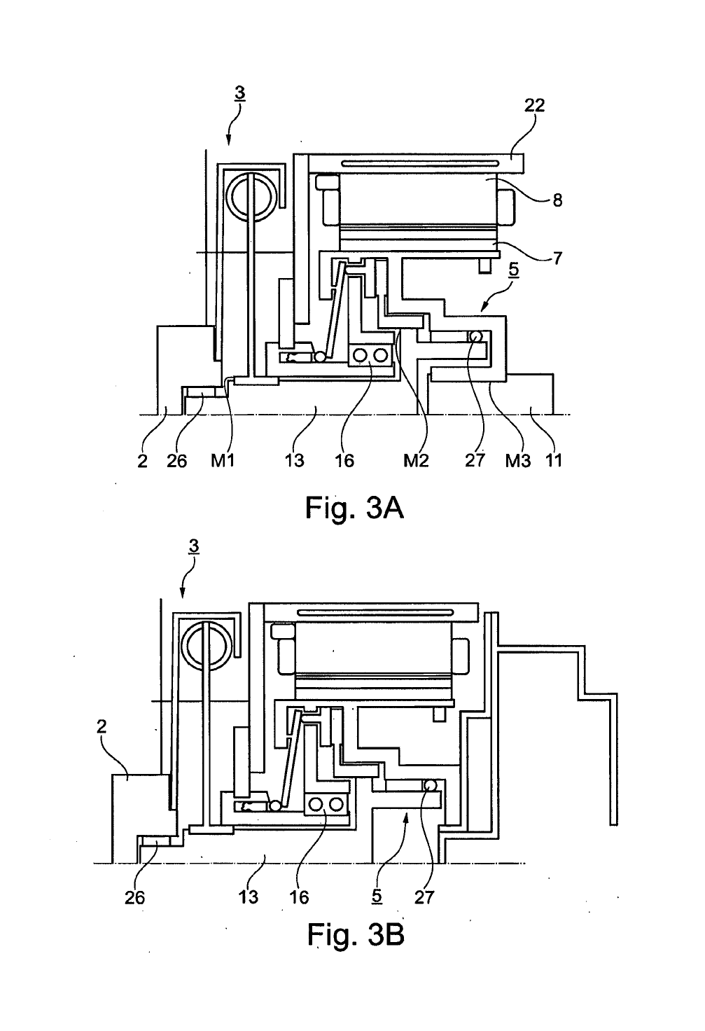

Hence FIGS. 3A and 3B show exemplary embodiments in which the intermediate shaft 13 is supported on the engine side directly into the crankshaft 2 by means of a pilot bearing 26, which may be implemented as a journal bearing or as a roller bearing. Furthermore, on the transmission side, depending on the function of the freewheeling mechanism 5 (see the discussion of the functions or operating states above), the intermediate shaft 13 is supported either by means of the freewheeling bodies themselves, when the freewheeling mechanism 5 is engaged, or for example by means of a deep groove ball bearing 27 when the freewheeling mechanism 5 is disengaged. Viewed axially, the bearing point 27 next to the freewheeling bodies may be situated either to the left or to the right of the freewheeling mechanism. The intermediate shaft 13 is thus supported on a good bearing base (i.e., the broadest possible). However, radial misalignments between the crankshaft axis and the freewheel axis X also act on the freewheeling mechanism as an additional tipping moment under the function of freewheeling mechanism 5 engaged. FIG. 3A shows in this case an application of the hybrid module having a dual-clutch transmission (not shown in detail), which is connected to the hybrid module through the input shaft or input hub 11. FIG. 3B shows in this case an application of the hybrid module having a stepped automatic transmission with converter (not shown in detail).

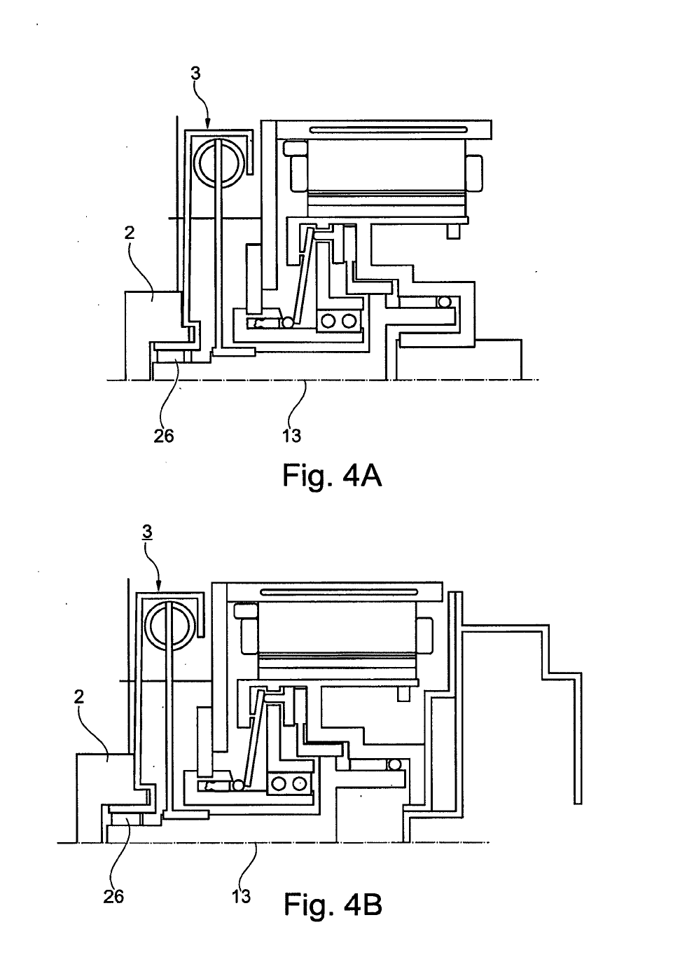

FIGS. 4A and 4B show additional exemplary embodiments having slightly modified bearing variants compared to the exemplary embodiments in FIGS. 3A and 3B. Hence these FIGS. 4A and 4B show exemplary embodiments in which the intermediate shaft 13 is supported on the engine side into the primary side of the damper 3 by means of a pilot bearing, which may be implemented as a journal bearing or as a roller bearing. The primary side of the damper itself is centered in turn on the crankshaft 2. Otherwise, the bearing variants according to FIGS. 4A and 4B correspond to the exemplary embodiments in FIGS. 3A and 3B. FIG. 4A shows in this case an application of the hybrid module having a dual-clutch transmission, which is connected to the hybrid module through the input shaft or input hub 11. FIG. 4B shows in this case an application of the hybrid module having a stepped automatic transmission with converter (not shown in detail).

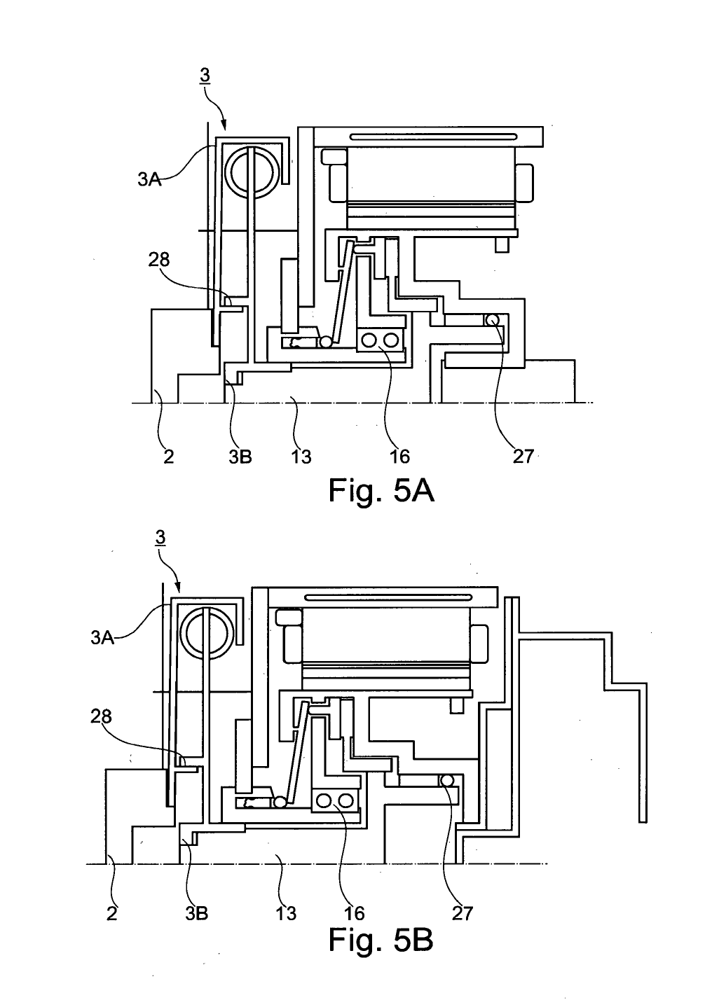

FIGS. 5A and 5B show additional exemplary embodiments having slightly modified bearing variants compared to the exemplary embodiments in FIGS. 3A and 3B and 4A and 4B. Thus FIGS. 5A and 5B show exemplary embodiments in which the intermediate shaft 13 is centered on the engine side in the secondary side 3B of the damper 3 by means of a bearing point 28. In this variant, no relative movement of the bearing point 28 in a circumferential direction develops. This centering 27 can be of correspondingly simple design. However, in this case the secondary side 3B of the damper 3 must be supported either on the primary side 3A of the damper 3 or directly on the crankshaft 2, using either a journal bearing or a roller bearing. On the transmission side the bearing system is designed as already explained in connection with the exemplary embodiments according to FIGS. 3A, 3B and 4A, 4B. FIG. 5A shows an application having a dual-clutch transmission, FIG. 5B shows the application having a stepped automatic transmission with converter.

A common feature of the exemplary embodiments described above according to FIGS. 3A, 3B, 4A, 4B and 5A, 5B is that the intermediate shaft of a free-wheel decoupling clutch is supported on the one hand on the engine side in a pilot bearing, and on the other hand by a bearing in the vicinity of the freewheeling mechanism or by the freewheeling body itself. As a result, skewing of the intermediate shaft on the engine side is prevented or reduced by radial forces on the secondary side of the damper. The other features of the hybrid module or of the drivetrain (including specifically those described in connection with FIGS. 1 and 2) are in all cases part of the exemplary embodiments described above.

What is claimed is:

1. A hybrid module for a drivetrain of a vehicle having a combustion engine, a torsional vibration damper, the hybrid module and a transmission, the hybrid module operating between the combustion engine and the transmission, the hybrid module comprising:
an electric drive;
a decoupling clutch; and
a freewheeling mechanism, the decoupling clutch and the freewheeling mechanism, parallel to each other, each of the decoupling clutch and the freewheeling mechanism provided to transmit torque from the combustion engine in the direction of the transmission, the freewheeling mechanism disengaging in the case of torque in the opposite direction, the torsional vibration damper and the hybrid module being connected with each other through an intermediate shaft supported on the engine side through a pilot bearing system directly on a crankshaft of the combustion engine, or indirectly on the crankshaft through the torsional vibration damper.

2. The hybrid module as recited in claim 1, wherein, depending on the operating state of the freewheeling mechanism, the intermediate shaft is supported on the transmission side either through freewheeling bodies when the freewheeling mechanism is engaged, or through a bearing when the freewheeling mechanism is disengaged.

3. The hybrid module as recited in claim 2 wherein the bearing is a deep groove ball bearing or a journal bearing.

4. The hybrid module as recited in claim 1 wherein a portion of the torque generated by the combustion engine transmitted by the freewheeling mechanism is set by adjusting a torque transmissible by the decoupling clutch, so that the vehicle is optionally propelled by the combustion engine or the electric drive or simultaneously by both of them combined, or wherein the decoupling clutch is designed to be engaged in a normal state.

5. The hybrid module as recited in claim 1 wherein the freewheeling mechanism is situated axially behind the torsional vibration damper in the direction from the combustion engine to the transmission device.

6. The hybrid module as recited in claim 1 wherein the decoupling clutch comprises a clutch housing connected to the transmission input shaft by a first rotationally fixed connection, a rotor of the electric drive transmitting torque to thereto, the freewheeling mechanism being situated in the flow of torque between the crankshaft and the clutch housing, the freewheeling mechanism being situated between the intermediate shaft and the clutch housing.

7. The hybrid module as recited in claim 6 wherein the first rotationally fixed connection is a first axial spline connection.

8. The hybrid module as recited in claim 1 wherein the intermediate shaft is connected to a secondary side of the torsional vibration damper by a rotationally fixed and axially movable first connection or wherein the intermediate shaft is connected to a hub of a clutch plate of the decoupling clutch by a rotationally fixed and axially movable second connection.

9. The hybrid module as recited in claim 8 wherein the first movable connection is a first axial spline connection, and the second connection is a second axial spline connection.

10. The hybrid module as recited in claim 1 further comprising a central bearing supporting a clutch housing of the clutch axially and radially on a transmission housing of the transmission.

11. The hybrid module as recited in claim 1 further comprising a hydraulic or pneumatic or electromechanical or electrical actuating unit to actuate the decoupling clutch, and a central bearing situated on a housing of the actuating unit.

12. The hybrid module as recited in claim 1 wherein the decoupling clutch is situated radially within a rotor of the electric drive and axially at least partially overlapping with the rotor of the electric drive, the rotor of the electric drive being non-rotatingly connected to a clutch housing of the clutch or integrally formed with the clutch housing.

13. The hybrid module as recited in claim 1 wherein an inner ring of the freewheeling mechanism simultaneously takes over a linkage to a clutch plate of the clutch as well as to the crankshaft, and an outer ring of the freewheeling mechanism is connected to a transmission input of the transmission, or wherein an inner ring of the freewheeling mechanism is connected to the transmission input and an outer ring of the freewheeling mechanism simultaneously takes over the linkage to the clutch plate as well as to the crankshaft.

14. A drivetrain of a vehicle comprising: a combustion engine, a torsional vibration damper, a transmission, and the hybrid module as recited in claim 1.
